(19) United States
(12) Patent Application Publication
(10) Pub. No.: US 2008/0288439 A1
(43) Pub. Date: Nov. 20, 2008

(54) COMBINED PERSONAL AND COMMUNITY LISTS

(75) Inventors: ADRIAN M. CHANDLEY, SAMMAMISH, WA (US); GAIL I. BURKE, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/748,119

(22) Filed: May 14, 2007

(51) Int. Cl. G06F 17/00; G06F 3/048; G06F 17/30

(52) U.S. Cl. 707/1; 707/104.1; 715/769; 707/E17.005

(57) ABSTRACT

Presented are techniques for creating a relationship between a community list of information and a personal list of information in order to transfer data between each list. In one technique, a community interface is displayed including a community list of information available to users within a community. Additionally, a personal interface is displayed including a personal list of information, wherein the personal list of information is available only to a user that creates the personal list of information. Furthermore, copies of an item of interest can be transferred from the community list into the personal list between the personal and community interfaces.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

The Internet has become an valuable resource for users to obtain information about diverse topics of interest. Many networking websites have been created in which users can share and exchange information about such diverse topics. One such website is a wiki. A wiki is generally a user-maintained database for creating, browsing and searching information. A wiki is a website that allows users to add, remove, edit and change content of various topics of interest. A significant characteristic of wiki technology is the ease with which pages can be created and updated as many wikis are open to the general public without the need to register any user account.

Unfortunately, wikis typically represent data as it was when the last user made an edit, thus wikis are open to abuse which the community is expected to self-regulate. Additionally, one person's opinion of an item of interest within the wiki may not always agree with everyone else's opinion and so harmony cannot always be reached. Accordingly, there exists a need to allow users to customize their own personal view of information represented within a wiki, such that changes made to information within the wiki does not necessarily affect a user's personalized view.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Presented are techniques to create a relationship between a community list of information and a personal list of information in order to transfer of data between each list. In one technique, a community list of information available to users within a community is provided. The community list of information includes items of interest to one or more users within the community. Also provided is a personal list of information, wherein the personal list of information is available only to a user that creates the personal list of information. Furthermore, the community list of information can be updated based on a modification of the personal list of information.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of an exemplary network environment for implementing the present invention.

FIG. 2 is a block diagram of an embodiment of an exemplary system for implementing the invention.

FIG. 3 illustrates a display screen that incorporates an exemplary personal list UI and an exemplary community list UI.

FIG. 4 is a flow diagram of an exemplary method for creating a relationship between a community list of information and a personal list of information in order to transfer data between each list.

FIG. 5 is a flow diagram of another exemplary method for creating a relationship between a community list of information and a personal list of information in order to transfer data between each list.

### DETAILED DESCRIPTION

Embodiments of the invention provide for a community populated list of data that a community is authorized to access and develop and allow users of the community to create their own personal view of the data within the community list that persists even if the community data is changed. Accordingly, the community data becomes a tool or repository from which the user can find, use, or contribute items of interest, and so that the users can store a personalized view of the community data that interests them.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

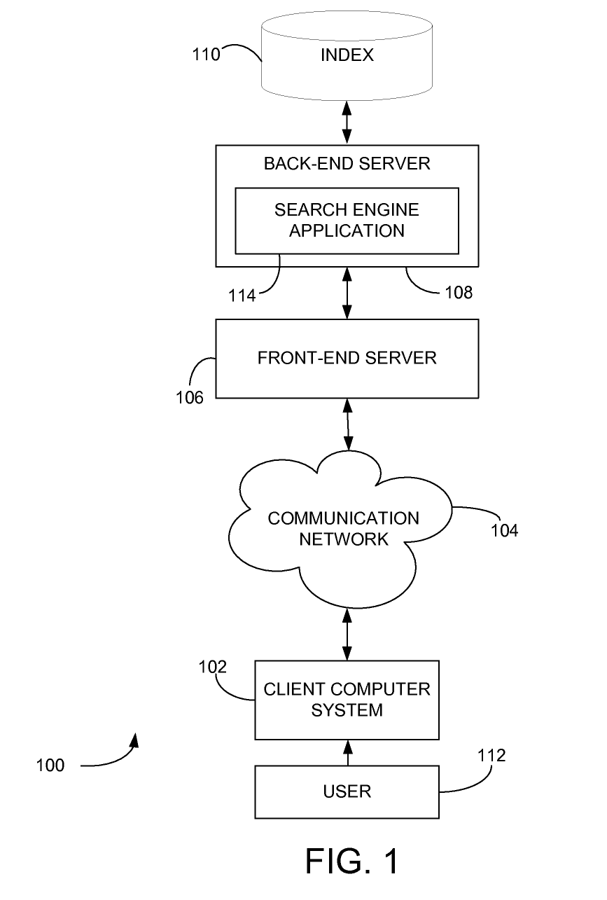

Referring initially to FIG. 1, an exemplary network environment for implementing the present invention is shown and designated generally as network environment 100. Network environment 100 is but one example of a suitable environment and is not intended to suggest any limitation as to the scope of use or functionality of the invention. Neither should the network environment 100 be interpreted as having any dependency or requirement relating to any one or combination of elements illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, specialty computing devices, servers, etc. The invention may also be practiced in distributed computing environments where tasks are performed by remote-processing devices that are linked through a communications network.

Network environment 100 includes a client 102 coupled to a network 104 via a communication interface. The communication interface may be an interface that can allow the client to be directly connected to any other device or allows the client 102 to be connected to a device over network 104. Network 104 can include, for example, a local area network (LAN), a wide area network (WAN), or the Internet (or the World Wide Web). In an embodiment, the client 102 can be connected to another device via a wireless interface through a wireless network 104.

One or more servers communicate with the client 102 via the network 104 using a protocol such as Hypertext Transfer Protocol (HTTP), a protocol commonly used on the Internet to exchange information. In the illustrated embodiment, a front-end server 106 and a back-end server 108 (e.g., web server or network server) are coupled to the network 104. The client 102 employs the network 104, the front-end server 106 and the back-end server 108 to access data stored, for example, in a central data index (index) 110.

Embodiments of the invention provide searching for relevant data by permitting search results to be displayed to a user 112 in response to a user-specified search request (e.g., a search query). In one embodiment, the user 112 uses the client 102 to input a search request including one or more terms concerning a particular topic of interest for which the user 112 would like to identify relevant electronic documents (e.g., Web pages) or items of interest within a list. For example, the front-end server 106 may be responsive to the client 102 for authenticating the user 112 and redirecting the request from the user 112 to the back-end server 108.

The back-end server 108 may process a submitted query using the index 110. In this manner, the back-end server 108 may retrieve data for items of interest (i.e., search results) that may be relevant to the user. The index 110 contains information regarding electronic documents such as Web pages available via the Internet. Further, the index 110 may include a variety of other data associated with the electronic documents such as location (e.g., links, or URLs), metatags, text, and document category. In the example of FIG. 1, the network is described in the context of dispersing search results and displaying the dispersed search results to the user 112 via the client 102. Notably, although the front-end server 106 and the back-end server 108 are described as different components, it is to be understood that a single server could perform the functions of both.

A search engine application (application) 114 is executed by the back-end server 108 to identify web pages and the like (i.e., electronic documents) in response to the search request received from the client 102. More specifically, the application 114 identifies relevant documents from the index 110 that correspond to the one or more terms included in the search request and selects the most relevant items of interest to be displayed to the user 112 via the client 102.

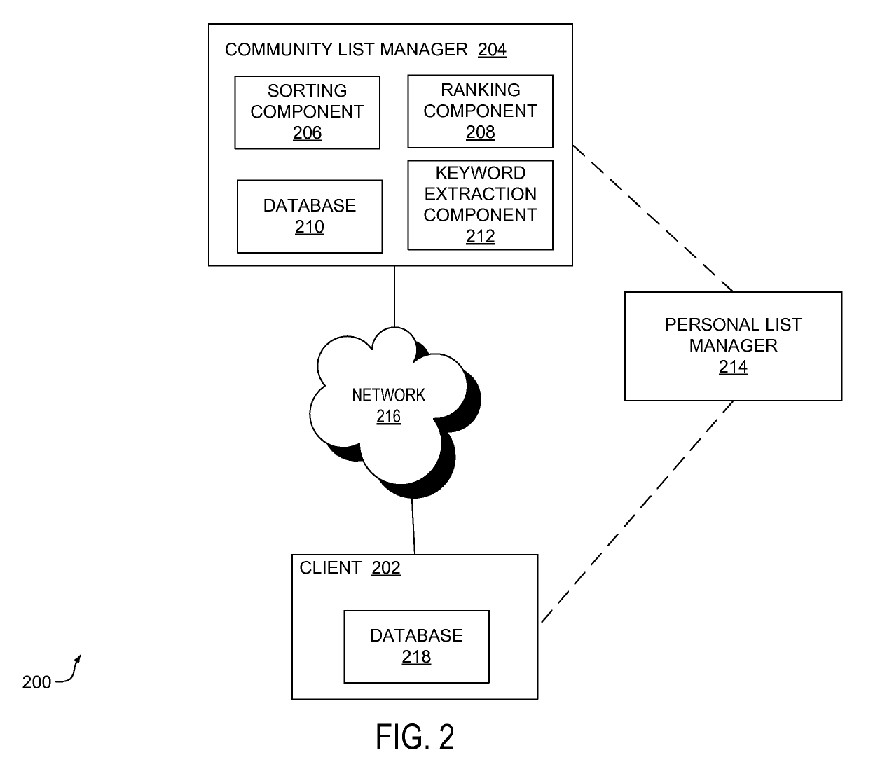

FIG. 2 is a block diagram of an embodiment of an exemplary system 200 for implementing the invention. The system 200 includes components such as client 202, community list manager 204, and personal list manager 214. Each component includes a communication interface. The communication interface may be an interface that can allow a component to be directly connected to any other component or allows the component to be connected to another component over network 216. Network 216 can include, for example, a local area network (LAN), a wide area network (WAN), or the Internet. In an embodiment, a device can be connected to another device via a wireless interface through the network 216.

Client 202 may be or can include a desktop or laptop computer, a network-enabled cellular telephone (with or without media capturing/playback capabilities), wireless email client, or other client, machine or device to perform various tasks including Web browsing, search, electronic mail (email) and other tasks, applications and functions. Client 202 may additionally be any portable media device such as digital still camera devices, digital video cameras (with or without still image capture functionality), media players such as personal music players and personal video players, and any other portable media device. Client 202 may also be or can include a server such as a workstation running the Microsoft Windows®, MacOS™, UniX™, Linux, Xenix™, IBM AIX™, Hewlett-Packard UX™, Novell Netware™, Sun Microsystems Solaris™, OS/2™, BeOS™, Mach™, Apache™, OpenStep™ or other operating system or platform.

Community list manager 204 may be or can include a server such as a workstation running the Microsoft Windows®, MacOS™, UniX™, Linux, Xenix™, IBM AIX™, Hewlett-Packard UX™, Novell Netware™, Sun Microsystems Solaris™, OS/2™, BeOS™, Mach™, Apache™, OpenStep™ or other operating system or platform. In an embodiment, community list manager 204 may comprise one or more of elements 106, 108, 110, and 114 of FIG. 1. Community list manager includes one or more of a sorting component 206, ranking component 208, database 210, and keyword extraction component 212. Database 210 includes a community list of information relating to items of interest to users within a community. Such a community may be, in an embodiment, as large as a worldwide community. In other embodiments, the community may be a subset of a worldwide community of people including people within a continent, a country, a state, a county, a city, or a group of people that are classified together by interest, family, profession, religion, any other demographic metric, or any other subset of a worldwide population. In the database 210, each item of interest may be associated and stored with, but not limited to, related information including a title of the item, a description of the item, user ratings of the item, links to other items of interest or other information, a date the item was added to the database, a name of the user that added the item to the database, keywords associated with the item, and other multimedia data including text, video, and audio content related to the item of interest.

In an embodiment, the community list manager 204 has a web page with a user interface (UI) that users within the community can utilize in order to view and add information to the community list. In an embodiment, the community list of information is within database 210 is initially and subsequently generated by users accessing the community list UI and adding items of interest and other related information as discussed above. Community list manager 204 is also configured to respond to requests by users of client 202 for community information stored within database 210. Requests from users may be received by the community list manager 204 in the form of search queries. The search queries may include one or more keywords to filter the database for a item of interest that the requesting user is interested in retrieving. In an embodiment, the UI of the community list may include predetermined keywords that a user can select in order to filter the database 210 and retrieve information related to the user's interest. In another embodiment, the user can enter his/her own keywords that will be used to filter the database 210. Once the keywords within the search query is received by the community list manager 204, the sorting component 206 can evaluate the keywords to determine which items of interest within the database 210 correspond to the received keywords. This determination can be made by the sorting component comparing the received keywords with the keywords associated with each item of interest within the database 210.

In an embodiment, the keywords associated and stored with an item of interest in database 210 may be received from a user. Such a user may be the original user that initially added the item of interest into the database 210, or from a subsequent user that has viewed the item of interest. In another embodiment, the keywords associated and stored with an item of interest within database 210 may be created by keyword extraction component 212. Keyword extraction component 212 may include a conventional keyword extraction algorithm known in the art. The keyword extraction component 212 can extract keywords from a description associated with the item of interest in the database, or it can extract keywords from any other piece of multimedia data associated with the item of interest in the database 210. The keyword extraction component 212 can be configured to extract keywords when the item of interest is initially created in database 210, periodically when information related to the item of interest changes over time, or on-the-fly when a search query is received from a user.

Once the sorting component 206 has compiled a list of items that match the keywords in the search query, the ranking component 208 is utilized to rank the items within the list. The ranking component can rank the sorted items based on ranking criteria. In an embodiment, the ranking criteria is the user ratings associated with the items of interest stored within database 210. The user ratings may be received by users that have previously viewed the item of interest and that have decided to rate the item of interest. For example, the community list UI may include an interface for allowing users to provide feedback and rate the item of interest viewed by the user. There may be multiple different rating options available to the user. For example, a user can rate the item of interest using a objective rating system. In such an example, the user may be presented with an interface in which the user can rate the item of interest on a numeric scale, 1-5 for example, wherein 5 could be the most favorable rating for the item and 1 could be the least favorable rating. Another example could be presenting an interface to the user in which the user can select from any number predefined textual descriptions that can be used to rate the item of interest. For example, the interface may contain such terms as “extremely useful,” “useful,” “somewhat useful,” and “not useful at all” that the user can select as feedback regarding the particular item of interest. In another embodiment, the user may be presented with an option to fill-out a feedback form within the community list UI in which the user can freely type-in his/her thoughts about the item of interest. In such an embodiment, the ranking component may include code for evaluating the freely typed-in text and can rate the item using an objective rating system, or an administrator can evaluate the freely typed-in text and can rate the item using an objective rating system. Once the ranking component has evaluated the ratings of each item within the sorted list, the ranking component can rank the items according to their ratings. Typically, items with in the highest (most favorable) ratings will be ranked higher and will be placed at the top of the list. Once the items of interest have been ranked, the ranked items can be displayed to the user within the community list UI.

Personal list manager 214 is used to allow a user to keep his/her own personal view of the community list information stored in database 210. In an embodiment, personal list manager 214 may be a component included within community list manager 204 or within another server. In another embodiment, personal list manager 214 is stored locally on client 202. In such an embodiment, the personal list manager may be stored as a cookie on client 202, or the personal list manager may be stored as some other software/hardware component within client 202.

Personal list manager 214 is configured to store a user profile for one or more users of client 202. A user profile can include demographic information regarding the user as well as certain preferences of the user. Such preferences can include frequently-used keywords by the user, a list of previously-used keywords, and any previously-created ratings for any of items of interest. In an embodiment, the user profile can be used to filter database 210 in a response to a search query from a user. For example, when a user decides to utilize a searching interface of the community list UI, the keywords and ratings within the user's profile can be automatically retrieved and used by the sorting component 206 and ranking component 208 in order to sort and rank information within database 210 according the user's preference. In another example, the user may first select an option within the community list UI that instructs the community list manager to retrieve the user's preferences from his/her user profile for sorting and ranking purposes.

Additionally, the personal list manager 214 is configured to present a separate personal list UI to the user that includes saved data representing a personal and customized view of information within the community list of information. The saved data includes a personal list of information that is only available to the user that is the owner of the user profile. The personal list UI can be displayed next to the community list UI within a display screen of client 202. The personal list UI includes an interface that allows a user to import items of interest from the community list into the user's personal list, add new items of interest to the personal list that are not found in the community list, export the newly added items to the community list, and rate or rank items of interest within the personal list. In an embodiment, the user can initially create his/her personal list by importing items of the interest from the community list.

When a user imports an item of interest from the community list into his/her personal list, the personal list manager 214 will obtain a copy of the item of interest as well as the other information related to the item that is stored in database 210. The personal list manager 214 will then store the copy in database 218. In embodiments in which the personal list manager 214 is part of a third-party server, the personal list manager will store the copy in a database of the third-party server under a user profile designated for the particular user. In embodiments in which the personal list manager 214 is included within community list manager 204, the personal list manager will store the copy under a user profile designated for the particular user, wherein the user profile is located within database 210 or another database associated with the community list manager 204.

When a user creates a new item of interest within his/her personal list that is not found within the community list, the user can add and associate information within database 218 that is related to the item of interest. Such related information can include, but is not limited to, the title of the item of interest, a description of the item, user ratings of the item, links to other items of interest or other information, a date the item was added to the database, a name of the user that added the item to the database, keywords associated with the item, and other multimedia data including text, video, and audio content related to the item of interest. When a user or client 202 exports the item of interest from the user's personal list into the community list, a copy of the item, including the other related information, is transmitted and stored within database 210. In fact, in an embodiment, exporting newly added items from a personal list into the community list is a way in which the community list can be initially generated. Alternatively, a user may decide to create a new item of interest within the community list. The user can associate the same type of related information which will stored along with the item of interest within database 210. A user can then export the newly-created item of interest into his/her personal list, wherein a copy of the item of interest, including the related information, is transmitted and stored within database 218.

In an embodiment, the personal list manager 214 can be configured to automatically update the community list database 210 whenever a modification has been made to the personal list. Such modifications can include, but are not limited to: adding a new item of interest into the personal list that is not from the community list, deleting an item of interest from the personal list, ranking items of interest within the personal list, adding multimedia content related to an item of interest within the personal list, deleting multimedia content related to an item of interest within the personal list, and editing multimedia content related to an item of interest within the personal list. When a modification is made, a corresponding update is made to the community list of information. For example, a newly added item of interest from the personal list can be added into the community list along with the other related information, items of interest within the community list can be re-ranked based on a user's ranking or rating scheme within their personal list, an item of interest can be deleted from the personal list can be deleted from the community list, and multimedia content related to an item of interest within the personal list that is added, deleted, or edited can be added, deleted, or edited correspondingly in the community list.

In an embodiment, changes to items of interest or information related to the items of interest within the community list of information will not affect the information within the user's personal list. This is done in order to keep a user's personal list separate and independent of the community list. In this embodiment, the user can maintain his/her personal ranking preferences, rating preferences, and storage of the related information of the items of interest that he/she has created or imported from the community list. In an embodiment, the community list manager 204 can inform the personal list manager 214 that a change has been made to an item of interest within the community database 210. This can be done periodically or each time a change is made to an item of interest within database 210. Additionally, the community list manager can be configured to recognize when a change has been made to an item of interest that is within the user's database 218, and can inform the user's personal list manager that a change has been made. Once the personal list manager 214 is informed, the personal list manager can send a message to the user informing him/her of the changes that have been made. At that time the user can decide to deny or incorporate the changes into his/her personal list. If the user chooses to accept the changes, the personal list manager 214 can obtain the changes from the community list manager 204, incorporate the changes into database 218, and display the changes within the personal list UI.

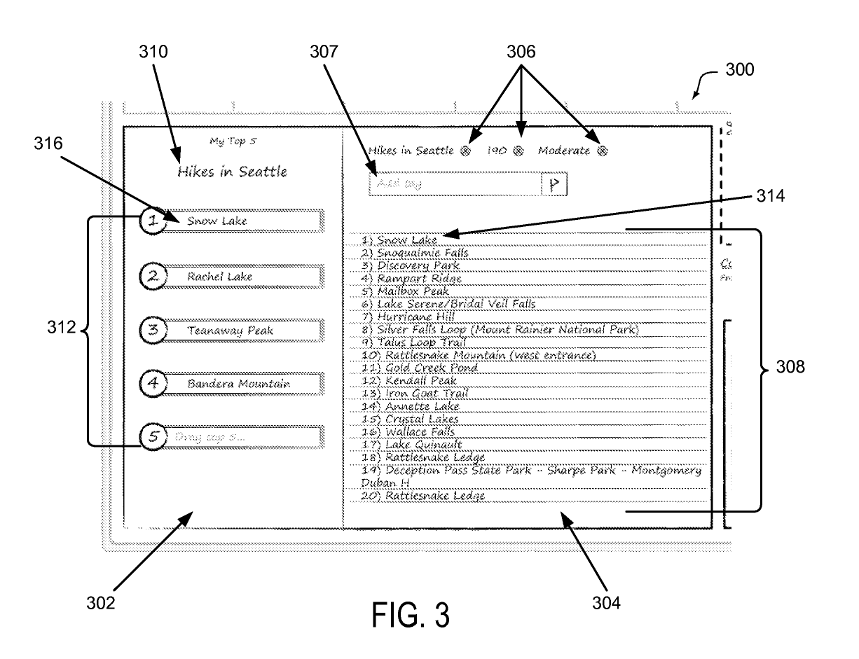

FIG. 3 illustrates a display screen 300 that incorporates an exemplary personal list UI 302 and an exemplary community list UI 304. As shown, the personal list UI 302 is to the left of the community list 304. However, in other embodiments, the personal list UI 302 may be above, below, to the right of the community list UI 304, or within a pop-up window. The community list UI 304 comprises an area that includes keywords 306 that have been used to sort the list of items of interest 308. The keywords 306 may include predetermined keywords that are part of the community list that a user may select, keywords that have been added by a user in the keyword input text-box 307, or keywords from a user profile. The items of interest 308 are ranked based on ranking criteria associated with each item within a database of the community list manager. Furthermore, the items 308 may be ranked based on a how users have ranked or rated the items within their personal lists.

Once the list of items 308 has been generated, a user can select an item, with a mouse cursor for example, and can drag the selected item into their personal list. For example, the “Snow Lake” item 314 from the community list UI 304 may have been imported into the personal list UI 302 and place in the top rated position 316 for topic of interest of “Hikes in Seattle” 310. When the “Snow Lake” item is imported into the personal list UI 304, a copy of the related information is also imported and stored in a database accessible to personal list manager of the UI 302. The other items of interest 312 in the second, third, and fourth rated positions in the personal list UI may include other items of interest imported from the community list UI 304, or the items may have been created by the user within the personal list UI 302. In instances in which the items were created within the personal list UI 302, a copy of the item as well as any other related information can be exported to a database accessible to the community list manger of the community list UI 304. Furthermore, in the example of the user importing the “Snow Lake” item from the community list and placing it in the top rated position, the placement, in addition to the rankings of the other items of interest within the personal list UI 302, will be used to further update the rankings in the community list.

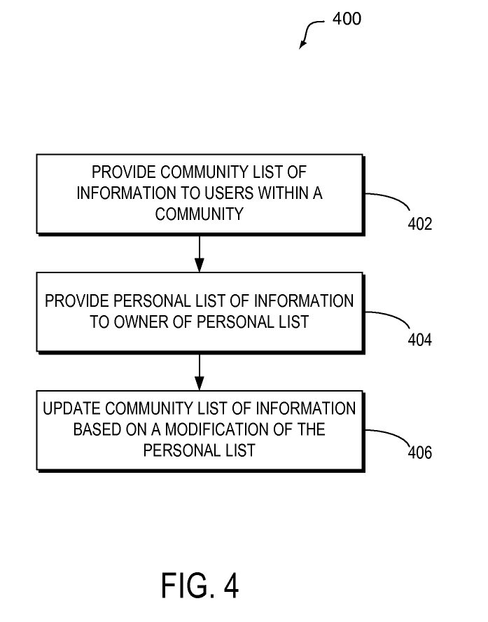

FIG. 4 is a flow diagram of an exemplary method 400 for creating a relationship between a community list of information and a personal list of information in order to transfer data between each list. At operation 402, a community list of information is provided and is available to users within a community. The community list includes items of interest to users within the community. At operation 404, a personal list of information is provided. The personal list of information is only available to a user that created the personal list or that has a user profile associated with the personal list. At operation 406, the community list is updated based on a modification of the personal list of information. The modification can include, but is not limited to, adding a new item of interest into the personal list that is not from the community list, deleting an item of interest from the personal list, ranking one or more items of interest within the personal list, adding multimedia content related to an item of interest within the personal list, deleting multimedia content related to an item of interest within the personal list, or editing multimedia content related to an item of interest within the personal list.

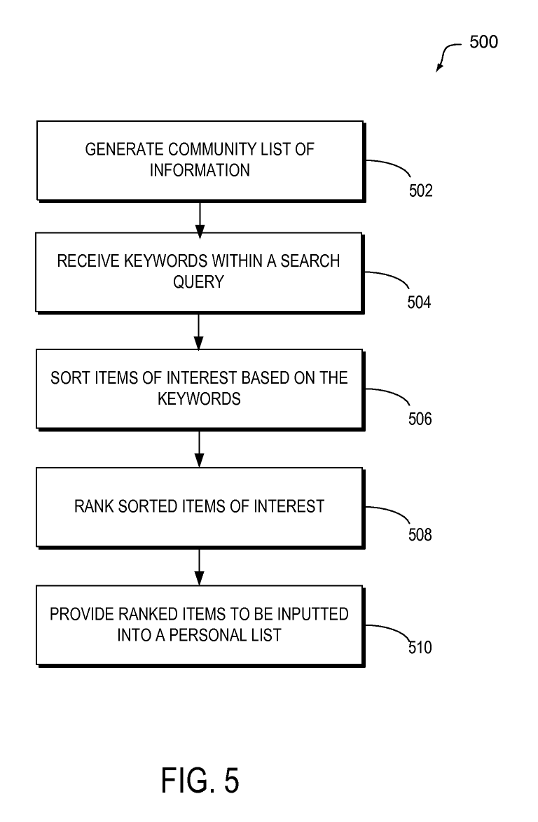

FIG. 5 is a flow diagram of another exemplary method 500 for creating a relationship between a community list of information and a personal list of information in order to transfer data between each list. At operation 502, a community list of information is generated such that the information is available to users within a community. The community list of information includes items of interest to the users within the community. At operation 504, keywords are received within a search query. The keywords may be received from a user profile or from a community list UI. At operation 506, the items of interest are sorted based on the keywords within the search query. The items may be sorted, for example, using the sorting component 206 of FIG. 2. At operation 508, the sorted items are ranked. The items may be ranked, for example, using the ranking component 208 of FIG. 2. Various ranking criteria outlined above with reference to FIG. 2 may be utilized when ranking the items. Additionally, the ranking or rating schemes of items of interest within personal lists of users may also be considered when ranking the sorted items. At operation 510, the ranked items are provided within a user's personal list of information, wherein the personal list is only available to the user that created the personal list or that has a user profile associated with the personal list.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

We claim:

1. A method for creating a relationship between a community list of information and a personal list of information in order to transfer data between each list, comprising:
providing a community list of information available to users within a community, the community list including items of interest to one or more users within the community;
providing a personal list of information, wherein the personal list of information is available only to a user that creates the personal list of information; and
updating the community list of information based on a modification of the personal list of information.

2. The method according to claim 1, wherein the personal list of information is created by selecting one or more items of interest from the community list.

3. The method according to claim 1, wherein the modification of the personal list of information comprises at least one of: adding a new item of interest into the personal list that is not from the community list; deleting an item of interest from the personal list; ranking one or more items of interest within the personal list; adding multimedia content related to an item of interest within the personal list; deleting multimedia content related to an item of interest within the personal list; and editing multimedia content related to an item of interest within the personal list.

4. The method according to claim 1, wherein updating the community list comprises at least one of: adding a new item of interest to the community list; ranking one or more items of interest; deleting an item of interest from the community list; adding multimedia content related to an item of interest within the community list; deleting multimedia content related to an item of interest within the community list; and editing multimedia content related to an item of interest within the community list.

5. The method according to claim 1, further comprising updating the community list based on user feedback inputted directly into the community list.

6. The method according to claim 1, wherein changes made to the community list of information do not affect the personal list of information.

7. The method according to claim 1, further comprising informing a user that a change regarding one or more items of interest within the personal list have been changed within the community list.

8. The method according to claim 7, further comprising updating the personal list according to the change.

9. A method for creating a relationship between a community list of information and a personal list of information in order to transfer data between each list, comprising:
generating a community list of information available to users within a community, the community list including items of interest to one or more users within the community;
receiving one or more keywords within a search query;
sorting the items of interest within the community list based on the one or more keywords;
ranking the sorted items of interest; and
providing one or more items from the ranked items of interest to be inputted into a personal list of information, wherein the personal list is only available to a user that created the personal list.

10. The method according to claim 9, wherein the community list is generated by users inputting items of interest directly into an interface of the community list.

11. The method according to claim 9, wherein one or more items of interest are each associated with a corresponding set of multimedia data within the community list of information.

12. The method according to claim 9, wherein the community list is generated by users inputting items of interest directly into an interface of the personal list, wherein the inputted items of interest are transferred into the community list.

13. The method according to claim 9, wherein the one or more keywords are derived from at least one user profile.

14. The method according to claim 9, wherein the one or more keywords are predetermined keywords selected by the user.

15. The method according to claim 9, wherein the one or more keywords are new keywords added by the user.

16. The method according to claim 15, wherein the sorted items are ranked based on one or more items of interest ranked within one or more personal lists.

17. The method according to claim 15, wherein the sorted items are ranked based on users inputting ranking criteria directly into an interface of the community list.

18. The method according to claim 9, further comprising extracting keywords common to the provided one or more items of interest and incorporating the extracted keywords into a user profile of the user.

19. A graphical user interface embodied on one or more computer-readable media and executable on a computer for presenting on a display screen user interfaces for creating a relationship between a community list of information and a personal list of information in order to transfer data between each list, the graphical user interface comprising:
a first screen area configured to display a community interface including a community list of information, the community list of information including items of interest to one or more users within the community; and
a second screen area configured to display a personal interface including a personal list of information, the personal list of information being available only to a user that creates the personal list of information,
wherein copies of an item of interest can be transferred from the community list into the personal list, and copies of items of interest can be transferred from the personal list into the community list.

20. The graphical user interface according to claim 19, wherein transferring a copy of an item of interest into the personal list modifies a ranking of one or more items of interest within the community list.
